(19) United States
(12) Patent Application Publication
(10) Pub. No.: US 2007/0291788 A1
(43) Pub. Date: Dec. 20, 2007

(54) METHOD AND APPARATUS FOR REDUCING TRANSMISSION OVERHEAD

(75) Inventors: Mohammed Sammour, Montreal (CA); Arty Chandra, Manhasset Hills, NY (US); John S. Chen, Downingtown, PA (US); Stephen E. Terry, Northport, NY (US); Peter S. Wang, E. Setauket, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/762,109

(22) Filed: Jun. 13, 2007

Related U.S. Application Data
(60) Provisional application No. 60/814,380, filed on Jun. 15, 2006.

(51) Int. Cl. H04J 3/16

(52) U.S. Cl. 370/466

(57) ABSTRACT

In a wireless communication system including a wireless transmit/receive unit (WTRU) and an evolved Node B (eNB) capable of transmitting and receiving wireless data, a method and apparatus for reducing transmission overhead includes receiving an upper layer sequence number (SN). The upper layer SN is converted into a radio link control (RLC) service data unit (SDU) SN (SSN). An RLC protocol data unit (PDU) is generated for transmission including an RLC SSN, and incurred transmission overhead is optimized.

### CROSS REFERENCE TO RELATED APPLICATION

This application claims the benefit of U.S. Provisional Application No. 60/814,380, filed Jun. 15, 2006, which is incorporated herein by reference as if fully set forth.

### FIELD OF INVENTION

The present invention is related to transmission overhead in a wireless communication system. More particularly, the present invention is related to a method and apparatus for reducing transmission overhead in a wireless communication system.

### BACKGROUND

The third generation partnership project (3GPP) has initiated a long term evolution (LTE) program to bring new technology, new network architecture and configuration, and new applications and services to the wireless cellular network in order to provide improved spectral efficiency, reduced latency, faster user experiences and richer applications and services with less cost.

In a wireless cellular network, it is not only the technology that is offered that is important, but also the privacy and accuracy of transmitted user data. On the technology, and especially in radio access network (RAN), the data privacy and accuracy concerns may be addressed by data block encryption, such as ciphering for both user data and control messages, as well as the placing and execution of an automatic repeat request (ARQ) protocol on the data path to recover lost or inaccurate data transmissions.

FIG. 1 is a functional block diagram of a conventional 3GPP UTRAN system 100, including a security ciphering entity and a radio link controller (RLC) layer ARQ entity. In the present 3GPP UTRAN system, the security ciphering entity and outer layer ARQ entity, (i.e., the RLC acknowledgement mode (AM) entity), are located in the same physical node, such as the user equipment (UE) and radio network controller (RNC). Both the data security and the ARQ use the RLC protocol data unit (PDU) sequence numbers as the input for the data block encryption and for retransmission acknowledgement checking.

FIG. 2 is a functional block diagram of an LTE network system 200 in which the UTRAN architecture has been replaced by an evolved UTRAN (EUTRAN) architecture. In this scenario, the RNC no longer exists and a new evolved NodeB (eNB) assumes the medium access control (MAC) functions and some radio resource controller (RRC) functionalities. The eNB also includes the RLC sub-layer, where the OuterARQ functionality and procedures may be placed and executed. Accordingly, in the LTE network architecture, the new data security (encryption/ciphering) entity lies above the RLC entity, unlike the older UTRAN architecture where ciphering was done on the RLC PDUs.

FIG. 3 is a functional block diagram of an LTE wireless communication system 300. As shown in FIG. 3, it has been proposed in the LTE working group that the OuterARQ entity, which may also simply be referred to as the “ARQ entity”, on the network side shall be located in the eNB as part of the RLC layer. This is to allow optimal retransmission delay, retransmission PDU size, simple protocol complexity, low buffering requirements, and possible hybrid ARQ (HARQ) and OuterARQ interaction for further optimization.

In the LTE specification 3GPP TR 25.813, V0.9.2, a network architecture is described having an RLC sub-layer in which the OuterARQ entity is located. The following is a description of the RLC sub-layer in the above document. RLC service data units (SDUs) are input into the RLC sub-layer, and RLC PDUs are output from the RLC sub-layer. Upper-layer PDUs, such as packet data convergence protocol (PDCP) PDUs, are viewed as RLC SDUs from the RLC sub-layer's point of view. The RLC layer performs functions such as error correction through the ARQ, where a retransmission mechanism is used to improve the reliability of packet delivery through identifying missing packets and retransmitting them, thereby reducing the residual packet error rate. Some applications may bypass the error correction functionality of the RLC sub layer. These packets are sent via unacknowledged mode RLC, with no error recovery.

Additionally, the RLC layer performs reordering. That is, in-sequence delivery of upper layer PDUs where the RLC layer reorders the packets before forwarding to higher layers. The RLC layer performs segmentation, where an RLC SDU may be broken up into multiple smaller RLC PDUs, whose size can be linked to, or dependent on, the size of the transport block (TB). The RLC segment size is not necessarily a constant, which implies that RLC PDUs may be of varying sizes. Resegmentation is performed by the RLC layer when necessary for retransmission, such as when the radio quality, (e.g., the supported TB size), changes. The RLC also performs concatenation, whereby multiple small RLC SDUs can be concatenated to form a single RLC PDU. However, the functional block diagram depicted in FIG. 3 does not address the details of the user data security architecture.

A drawback of this approach is that it does not address the OuterARQ. A simple approach for putting either the data security in the eNB or putting the OuterARQ entity in the aGW will not meet the expectation of LTE's new architecture security requirements and performance.

Accordingly, it would therefore be desirable to provide a method and apparatus for reducing transmission overhead that is not subject to the limitations described above.

### SUMMARY

The present invention is related to a method and apparatus for reducing transmission overhead. The method includes receiving an upper layer sequence number (SN). The upper layer SN is converted into a radio link control (RLC) service data unit (SDU) SN (SSN). An RLC protocol data unit (PDU) is generated for transmission including an RLC SSN, and incurred transmission overhead is optimized.

### BRIEF DESCRIPTION OF THE DRAWINGS

A more detailed understanding of the invention may be had from the following description of a preferred embodiment, given by way of example and to be understood in conjunction with the accompanying drawings wherein:

FIG. 1 is a functional block diagram of a conventional 3GPP UTRAN system;

FIG. 2 is a functional block diagram of an LTE network system;

FIG. 3 is a functional block diagram of an LTE wireless communication system;

FIG. 4 shows an exemplary wireless communication system including a wireless transmit/receive unit (WTRU), eNB, and aGW/eGSN, configured in accordance with the present invention;

FIG. 5 is a functional block diagram of the WTRU, eNB, and aGW/eGSN of the wireless communication system of FIG. 4;

FIG. 6A is a flow diagram of a method for reducing transmission overhead through sequence number (SN) removal and regeneration, in accordance with the present invention;

FIG. 6B is a flow diagram of a method for reducing transmission overhead through SN compression and decompression, in accordance with the present invention;

FIG. 7A is a flow diagram of a method for reducing transmission overhead through upper layer header removal and regeneration, in accordance with the present invention;

FIG. 7B is a flow diagram of a method for reducing transmission overhead through upper layer header compression and decompression, in accordance with the present invention;

FIG. 8A is an exemplary signal diagram of a current art communication scheme;

FIGS. 8B-8D are exemplary signal diagrams of wireless communication schemes in accordance with embodiments of the present invention;

FIG. 9 shows a plurality of concatenated PDCP PDUs without header compression; and

FIG. 10 shows a plurality of concatenated PDCP PDUs with header compression.

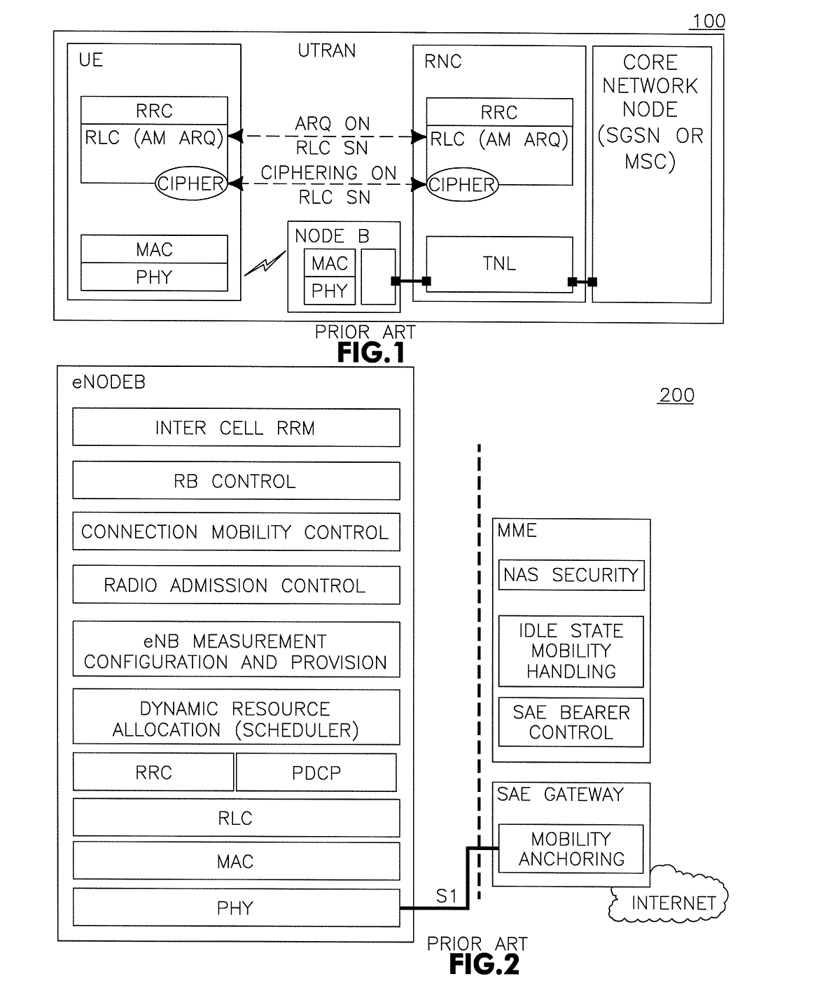

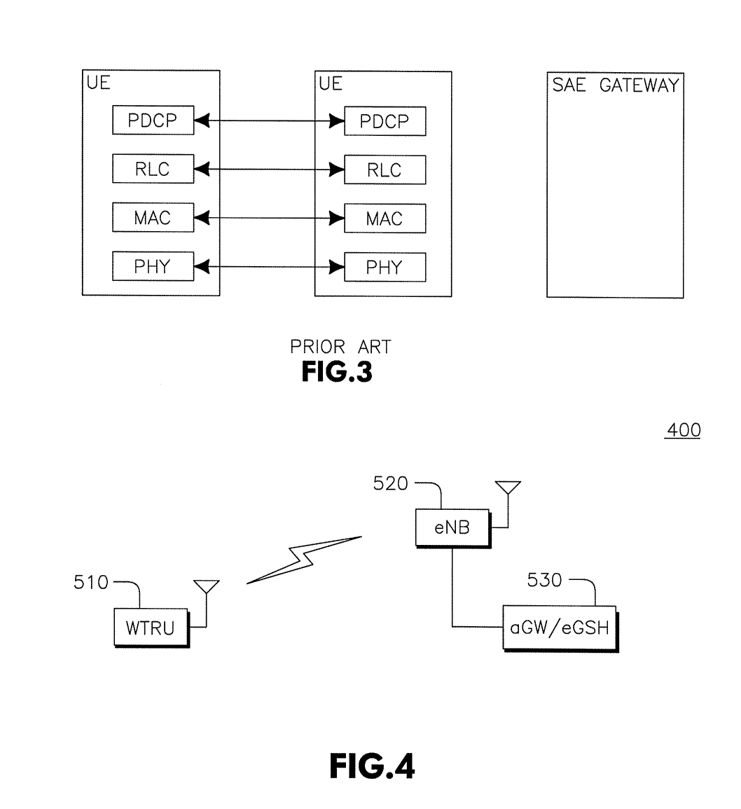

### DETAILED DESCRIPTION OF THE PREFERRED EMBODIMENTS

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

The present invention is directed toward mechanisms for translating upper layer sequence numbers (SNs) into radio link control (RLC) SNs, and vice versa, as well as mechanisms to optimize and/or reduce overhead incurred due to upper layer headers or upper layer SNs. Since sequence numbering is required by some RLC functions such as ARQ, reassembly, or reordering, and is also required by PDCP ciphering or reordering functions, it would be desirable to reduce transmission overhead, taking into account the architecture whereby a ciphering entity resides on top of an RLC entity. It would also be advantageous to handle resetting or re-initializing sequence numbers at the various layers in cases of error or handover scenarios.

An RLC SDU includes an SN, which may be referred to as an RLC SDU SN. A primary function of the RLC SDU SN is to identify the RLC SDU. An RLC PDU is typically identified using the SDU SN along with an additional field or fields, such as a segment number field or a bit or byte offset field, that provide information on the relative location or position of the segment within an RLC SDU.

Accordingly, the RLC performs sequence numbering of its SDUs, such as the upper-layer PDUs, which may be PDCP PDUs, and this sequence numbering may be explicitly included in each RLC segment. On the other hand, the RLC SDU SN may not be explicitly included or transmitted over the air, but rather implied or derived from RLC PDU sequence numbers and segmentation/reassembly information. Due to such a deterministic relationship, the PDCP SN can be derived from the RLC SSN, and the transmission overhead may be reduced by only including one of those two SNs and excluding the other. For example, the PDCP SN may be removed and the RLC SSN kept. This relationship can be implicitly known to both a receiving device and transmitting device, or signaled explicitly at the beginning, during operation, or at the occurrences of certain events such as errors or at handover.

Importantly, the transmitting node and the receiving node may have access to an RLC SDU SN, regardless of whether it is explicitly or implicitly communicated. The sequence numbering is typically performed on a per-flow basis, (e.g., upper-layer flow/session or an RLC ARQ queue basis), but for purposes of example, RLC SN or upper-layer SN is referred to hereinafter.

FIG. 4 shows an exemplary wireless communication system 400 including a WTRU 510, an eNB 520, and an aGW/eGSN 530, configured in accordance with the present invention. As shown in FIG. 4, the WTRU 510 is in wireless communication with the eNB 520, which is in communication with the aGW/eGSN 530. Although only one WTRU 510, one eNB 520, and one aGW/eGSN 530 are shown in FIG. 4, it should be noted that any combination of wireless and wired devices may be included in the wireless communication system 400.

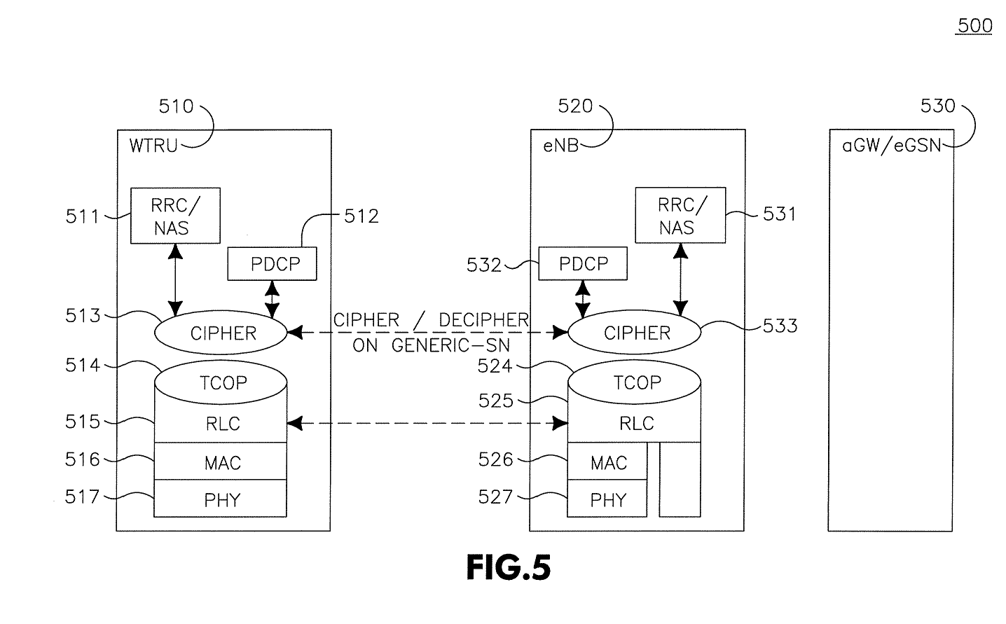

FIG. 5 is a functional block diagram 500 of the WTRU 510, eNB 520, and aGW/eGSN 530 of the wireless communication system 400 of FIG. 4.

The WTRU 510 includes a radio resource control (RRC)/network application server (NAS) layer 511, a PDCP layer 512, a cipher functional block 513, a translation, compression, optimization (TCOP) functional block 514, an RLC layer 515, a MAC layer 516, and a physical (PHY) layer 517. It is to be noted that for illustration purposes, the cipher functional block 513 is shown separately although preferably it is part of the PDCP layer 512.

The eNB 520 includes a TCOP functional block 524, an RLC layer 525, a MAC layer 526, a PHY layer 527, an RRC/NAS layer 531, a PDCP layer 532, and a cipher layer 533. Again, for illustration purposes, the cipher functional block 533 is shown separately although preferably it is part of the PDCP layer 312. The eNB 520 may also include transmission technology layers such as Ethernet and a GTP protocol (not shown).

Although the TCOP layer 514 of the WTRU 510 and TCOP layer 524 of the eNB 520 are shown in FIG. 5 as separate layers, for example as a sub-layer, it should be noted that the TCOP functions 514/524 of the WTRU 510 and eNB 520, respectively, may be included in other layers resident in the devices. Additionally, the WTRU 510, eNB 520, and aGW/eGSN 530 may include components typical for operation such as, among other things, processors, transmitters, receivers, and antennas.

Furthermore, in accordance with the present invention, the upper layer SN may be utilized for security, ciphering, and/or transmit and receive sequencing. The upper layer SN may also be of a particular size, for example 8-bits, and the RLC SDU SN may be of a particular size, for example 4 bits. The actual SN sizes may also be different taking into account different radio bearers and different channel rates. Also, in a preferred embodiment, the WTRU 510 may be considered a transmitter regarding uplink (UL) traffic, while the eNB 520 may be considered the transmitter regarding downlink (DL) traffic.

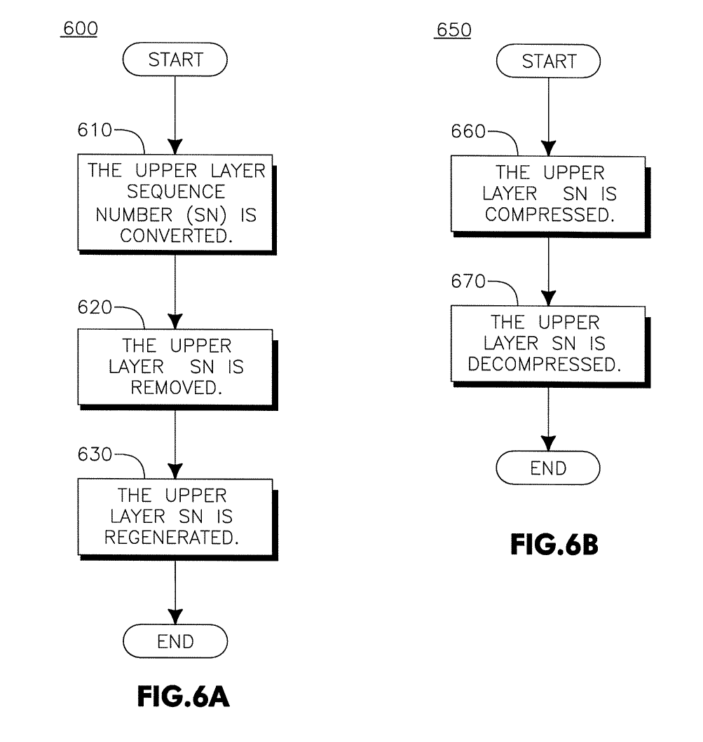

FIG. 6A is a flow diagram of a method 600 for reducing transmission overhead through sequence number (SN) removal and regeneration, in accordance with the present invention.

In step 610, the upper layer SN, (e.g., the common-SN or PDCP SN), is converted, which may also include translating or mapping the upper layer SN in an RLC SDU SN. Preferably, step 610 is performed at the transmitting node, but this is not required.

The conversion, translation, or mapping of an upper layer SN to an RLC SDU SN may be achieved by either reuse, truncation, or generalized mapping. In reusing, the RLC SDU SN is substantially similar to, and may be identical to, the upper layer SN. For example, if the upper layer SN is 01110101, then the RLC SDU SN is 01110101, assuming both have a size of 8 bits.

In truncation, the RLC SDU SN is equivalent to “n” least significant bits (LSBs) of the upper layer SN. For example, if the upper layer is again 01110101, then the RLC SDU SN is 0101. In this example, the upper layer SN has a size of 8 bits while the RLC SDU SN has a size of 4 bits.

In generalized mapping, a linear function may be used to convert the upper layer SN into an RLC SDU SN and vice versa. In one example, the linear function may be in accordance with the following equation:
RLC SDU SN=upper layer SN+x; Equation (1)
where x is an integer value representing an offset or shift. The mapping may also utilize the full upper layer SN as its input, or alternatively, only a part of the upper layer SN, (e.g., a truncated version). Similarly, the full output of the function, or a part of it, (e.g., a truncated version), can be used as the RLC SDU SN. For example, if the upper layer SN is 01110101, and the offset x is 3 in decimal, (i.e. 11 in binary), then the sum is 01111000, and the RLC SDU SN is 1000, assuming the upper-layer SN has a size of 8 bits and the RLC SDU SN has a size of 4 bits. In fact, truncation may be considered as a special case of generalized mapping, where the offset x is implied from the most significant bits (MSBs). For example, if the upper layer SN is 01110101, then the RLC SDU SN will be 0101, and the offset x is 01110000.

Generalized mapping may provide greater flexibility when compared to reuse or truncation. For example, if the RLC decides to reset or re-initialize the sequence numbers, then it can reset or re-initialize the RLC SDU SN on its own, without needing to make a request to upper layers, (e.g., to the PDCP layer) to change the upper layer SN. The RLC or TCOP simply needs to update and keep track of the offset (difference) between the upper layer SN and the RLC SDU SN when the RLC locally resets or re-initializes the RLC SDU SN such as in error scenarios or handover scenarios. For example, in a handover scenario, the PDCP SN may be continued across different cells, (i.e., is not reset or re-initialized), but the RLC SDU SN is reset or re-initialized to a new value via applying an updated offset (difference) to the PDCP SN.

Optimization or reduction of the upper layer SN overhead may be performed by removing the upper layer SN at the transmitter (step 620) and regenerating the upper layer SN at the receiver (step 630). During the regeneration process, the RLC SDU SN may be translated or mapped into an upper layer SN. This is preferably performed at the receiving node, which is the WTRU 510 in the case of downlink traffic Since a deterministic conversion between the upper layer SN and RLC SDU SN is possible, the transmitter may reduce the over-the-air overhead by implementing an upper layer SN removal. Since the upper layer SN can be derived, or regenerated, from the RLC SDU SN at the receiver, then the upper layer SN need not be transmitted, and can be removed from the upper layer packet, (e.g., from the PDCP PDU) at the transmitter.

In the reuse method, the transmitter creates the RLC SDU SN directly from the upper-layer SN, such as by copying it. For example, if the upper layer SN is 01110101, then the RLC SDU SN will also be 01110101. The transmitter then removes the upper layer SN from the upper layer header. If the upper layer SN is not always removed, a bit may be added to the RLC header or to the upper layer header to indicate whether the upper layer SN is present or has been removed. The receiver regenerates the upper layer SN directly from the RLC SDU SN, such as by copying it. For example, if the RLC SDU SN is 01110101, then the upper layer SN will also be 01110101.

In the generalized mapping and truncation methods, the transmitter creates the RLC SDU SN in any fashion. That is, the RLC SDU SN may or may not be directly based on the upper layer SN as long as a deterministic mapping can be used to derive one SN from the other SN. In the truncation case, the RLC SDU SN is directly created from the upper layer SN. The transmitter then removes the upper layer SN from the upper layer header. If the upper layer SN is not always removed, a bit may be added to the RLC header or to the upper layer header to indicate whether the upper layer SN is present or has been removed.

When needed or desired, the receiver is informed about the relationship (i.e. mapping) between the upper layer SN and the RLC SDU SN. In band signaling may be employed whereby both the RLC SDU SN and the upper layer SN are present in the same packet, so the relationship becomes obvious between the two. In this case, the upper layer SN is not removed from some of the packets. Alternatively, RRC signaling, such as with an activation timer, may be employed where the relationship, or mapping, between the upper-layer SN and the RLC SDU SN is conveyed via RRC messages or any other form of signaling. The receiver maintains (i.e. keeps track of and updates) the relationship between the upper layer SN and the RLC SDU SN, and regenerates the upper layer SN based on the most up-to-date relationship between the upper layer SN and the RLC SDU SN.

Below is an example assuming that the RLC SDU SN is 4 bits in size and the upper layer SN is 8 bits. For purposes of example, at a given reference time or point, the RLC SDU SN is 1100 and the upper layer SN is 01110101. The transmitter may convey the relationship between the RLC SDU SN and the upper layer SN via in band signaling and/or RRC signaling or any other form of signaling.

In in-band signaling, some packets, such as the first packet or first few packets, contain both the RLC SDU SN and the upper layer SN. That is, the upper layer SN is not removed. For example, the first packet contains the values 1100 and 01110101, and the second packet contains the values 1101 and 01110110, or the like.

In RRC signaling, the transmitter sends an RRC message indicating the relationship between the RLC SDU SN and the upper layer SN, (e.g., the offset between those two), for example with an activation timer to indicate the time when the relationship becomes valid. The RRC message may explicitly state both the RLC SDU SN and the upper layer SN, or the difference between the two at a given reference point.

The transmitter conveys the relationship between the RLC SDU SN and the upper-layer SN when there is a need, (e.g., during an initialization or setup phase, or when there is an RLC SDU SN reset/re-initialization or during handover), or when desired, (e.g., periodically to ensure the relationship is always in sync and to provide robustness against potential errors). The receiver stores the relationship between the RLC SDU SN and the upper layer SN, and maintains or updates the relationship when needed.

In the next example, in-band signaling is used in packet “N” which contains both the RLC SDU SN and the upper layer SN. It should be noted that RRC signaling indicating the relationship, (e.g., offset) between the RLC SDU SN and the upper layer SN may also be used and in such case packet N will contain just an RLC SDU SN. For purposes of example, assuming the following packets were sent from the transmitter, the receiver may perform updates as follows:
For packet N: RLC SDU SN=1100; upper layer SN=01110101. The receiver updates the relationship, (e.g., determines that the offset/difference is 1101001), and directly knows that packet N's upper layer SN is 01110101.
For packet N+1: RLC SDU SN=1101; upper layer SN is not included (i.e. it is removed). The receiver calculates that packet N+1's upper layer SN is 01110110, (e.g., via applying the relationship (such as the offset) to the received RLC SDU SN).
For packet N+2: RLC SDU SN=1110; upper layer SN is not included (i.e. it is removed). The receiver calculates that packet N+2's upper layer SN is 01110111, (e.g., via applying the relationship, (such as the offset), to the received RLC SDU SN).
For packet N+3: RLC SDU SN=1111; upper layer SN is not included (i.e. it is removed). The receiver calculates that packet N+3's upper layer SN is 01111000(e.g. via applying the relationship, (such as the offset), to the received RLC SDU SN).
For packet N+4: RLC SDU SN=0000; upper layer SN is not included (i.e. it is removed). The receiver calculates that packet N+4's upper layer SN is 01111001 (e.g. via applying the relationship, (such as the offset), to the received RLC SDU SN).

To facilitate implementing the arithmetic, the receiving RLC node may locally store or keep track of the RLC SDU SN using the same number of bits as that used for the upper layer SN, even though over-the-air the RLC SDU SN may be smaller.

FIG. 6B is a flow diagram of a method 650 for reducing transmission overhead through SN compression and decompression, in accordance with the present invention. In method 650, the upper layer SN may be compressed at the transmitter (step 660) and decompressed at the receiver (step 670). This may apply independent of the existence of an RLC SDU SN, or of the RLC details, although decompression may be facilitated by assistance or coordination from the RLC.

The procedures to keep track of, synchronize and regenerate the SNs are generally similar to those of removal case, but the relationship that has to be conveyed and used is now between the upper layer SN and the compressed version of the upper layer SN. Compression and decompression of the upper layer SN, (e.g., PDCP SN), may either occur at the upper layer endpoints, (e.g., PDCP endpoints), that reside in the eNB 520 or aGW/eGSN 530 and the WTRU 510, or at an intermediate layer or sub-layer that reside in the eNB 520 and the WTRU 510.

Additionally, the same upper-layer connection/session/flow, (e.g., PDCP flow), may switch from using a small upper layer SN, (e.g., the compressed PDCP SN), to a larger upper layer SN, (e.g., the uncompressed PDCP SN), on an as needed basis, such as during handover scenarios when a larger PDCP SN may be needed for reordering due to the potentially higher degree of out-of-order packets.

The transmitter may set a bit (or a field) in the RLC header or in the upper-layer (PDCP) header to indicate whether a compressed or uncompressed/full SN is present. The receiver by default knows how to extract the SN from the packet. Basically, either the standard defines the relationship between the compressed and uncompressed SN such as by pre-defining two sizes or formats, or prior negotiation, configuration, or setup messages, (e.g., RRC or any control signals) are exchanged to establish the various sizes/formats of the SN that can be exchanged. Hence, the transmitter uses such a bit, or field in general, to switch between two or more SN sizes/formats dynamically at any time. Alternatively, configuration via RRC or control signaling may be used to statically configure an SN size/format to be used, and where switching to another SN size/format is achieved via re-configuration at a later time.

Although optimization of upper layer header overhead may be performed with respect to the upper layer SN, which is part of the upper-layer header, optimization or reduction of the upper layer header overhead may also be performed.

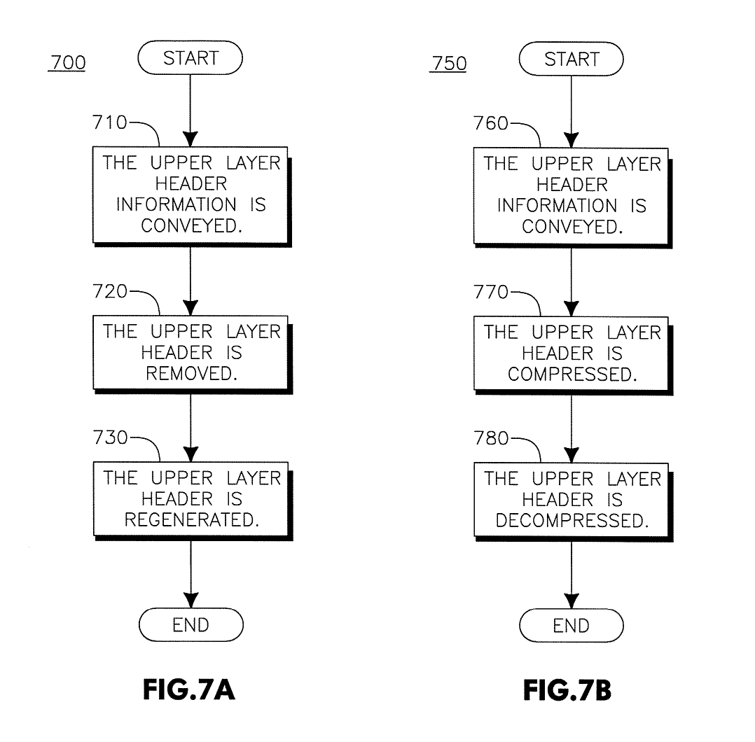

FIG. 7A is a flow diagram of a method 700 for reducing transmission overhead through upper layer header removal and regeneration, in accordance with the present invention. In step 710, the upper layer header information is conveyed so that it can be recovered by the receiver. Either all or some of the upper layer header information may be conveyed in the first PDCP header or the RLC header of what is to be the concatenated PDU. In step 620, the upper layer headers of remaining PDCP PDUs are removed, or alternatively not included, at the transmitter. At the receiver the upper layer header is regenerated (step 730), preferably utilizing information included in the first PDCP header or in the RLC header of the concatenated PDU.

FIG. 7B is a flow diagram of a method 750 for reducing transmission overhead through upper layer header compression and decompression, in accordance with the present invention. In this method, again some or all of the upper layer header information is conveyed in the first PDCP header or in the RLC header of the concatenated PDU (step 760). However, instead of removing the upper layer headers of the remaining PDCP PDUs, the upper layer headers is compressed at the transmitter in the concatenation (step 770) and decompressed at the receiver (step 780), preferably using the information in the first PDCP header or in the RLC header of the concatenated PDU and the compressed information of the PDCP PDUs. Such optimization may be applicable if concatenation of multiple PDCP PDUs is allowed as a function within the RLC sub-layer or elsewhere.

Any of the steps of methods 600, 650, 700, and 750 may be performed in combination with one another or independently of one another. For example, conversion of the upper layer SN (step 610) may be required for regenerating the SN that is removed and regenerated in steps 620 and 630, respectively. As another example, the compression and decompression of the upper layer SN in steps 660 and 670, the upper layer header removal and regeneration in steps 720 and 730, or the upper layer header compression and decompression in steps 770 and 780 may be performed. Alternatively, the steps of methods 600, 650, 700, and 750 may be performed irrespective of whether an RLC SDU SN is utilized to sequence number RLC SDUs. Additionally, in a preferred embodiment of the present invention, the methods 600, 650, 700, and 750 are performed in the TCOP functional block 514/524 which may reside in the RLC layers of the WTRU 510 and eNB 520, respectively. However, the methods 600, 650, 700, and 750 may also be performed in other layers of the WTRU 510 and eNB 520.

Additional variations of the method 700 are also possible. For example the upper layer SN may be removed at the transmitter but not regenerated at the receiver. The upper layer SN may be compressed or reduced at the transmitter, but not decompressed or expanded at the receiver. In one example, the upper layer SNs may be switched off during some period, such as during normal operation, and switched on at other periods, such as when a handover is expected or about to begin. Some examples of variations on the present invention are described below.

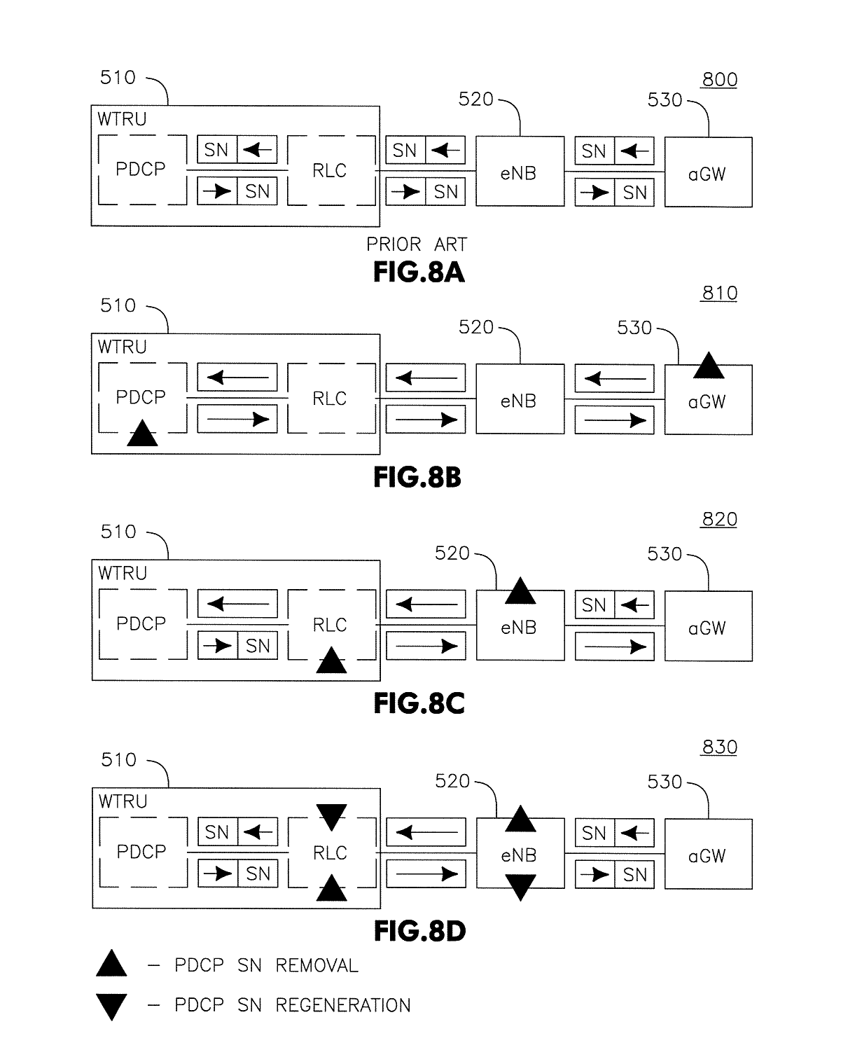

FIG. 8A is an exemplary signal diagram 800 of a current art communication scheme including the WTRU 510, the eNB 520, and the aGW/eGSN 530. In this example, the PDCP SN is switched on at all times and so the signals sent between all devices, in both UL and DL, include the SN. Hence, the transmission overhead is not minimized in this case since the SN is transmitted in every packet.

FIGS. 8B-8D are exemplary signal diagrams of wireless communication schemes in accordance with embodiments of the present invention. As shown in FIGS. 8B-8D, the aGW/eGSN 530 is shown as functioning as a PDCP endpoint transmitter. However, it should be noted that the PDCP endpoint transmitter and receiver functionality may also be included in the PDCP layer of the eNB 520.

FIG. 8B is an exemplary signal diagram 810 of a wireless communication scheme including the WTRU 510, the eNB 520, and the aGW/eGSN 530 in accordance with an embodiment of the present invention. In the example shown in FIG. 8B, the PDCP SN is removed by the PDCP endpoint transmitter (in this case the PDCP layer of WTRU 510) in the UL, and by the aGW/eGSN 530 in the DL. The PDCP endpoint receiver in this example will be required to handle numbered and unnumbered packets. In one example, the PDCP SN is removed in the case of no handover.

FIG. 8C is an exemplary signal diagram 820 of a wireless communication scheme including the WTRU 510, the eNB 520, and the aGW/eGSN 530 in accordance with another embodiment of the present invention. In this example, the PDCP SN is removed in the UL by the RLC layer of the WTRU 510 in the UL and by the eNB 520 in the DL. The PDCP endpoint receiver in this example will be required to handle numbered and unnumbered packets.

FIG. 8D is an exemplary signal diagram 830 of a wireless communication scheme including the WTRU 510, the eNB 520, and the aGW/eGSN 530 in accordance with another embodiment of the present invention. In this example, the PDCP SN is removed in the UL by the RLC layer of the WTRU 510 in the UL and by the eNB 520 in the DL, and regenerated by the RLC layer of the WTRU 510 in the DL and by the eNB 520 in the UL.

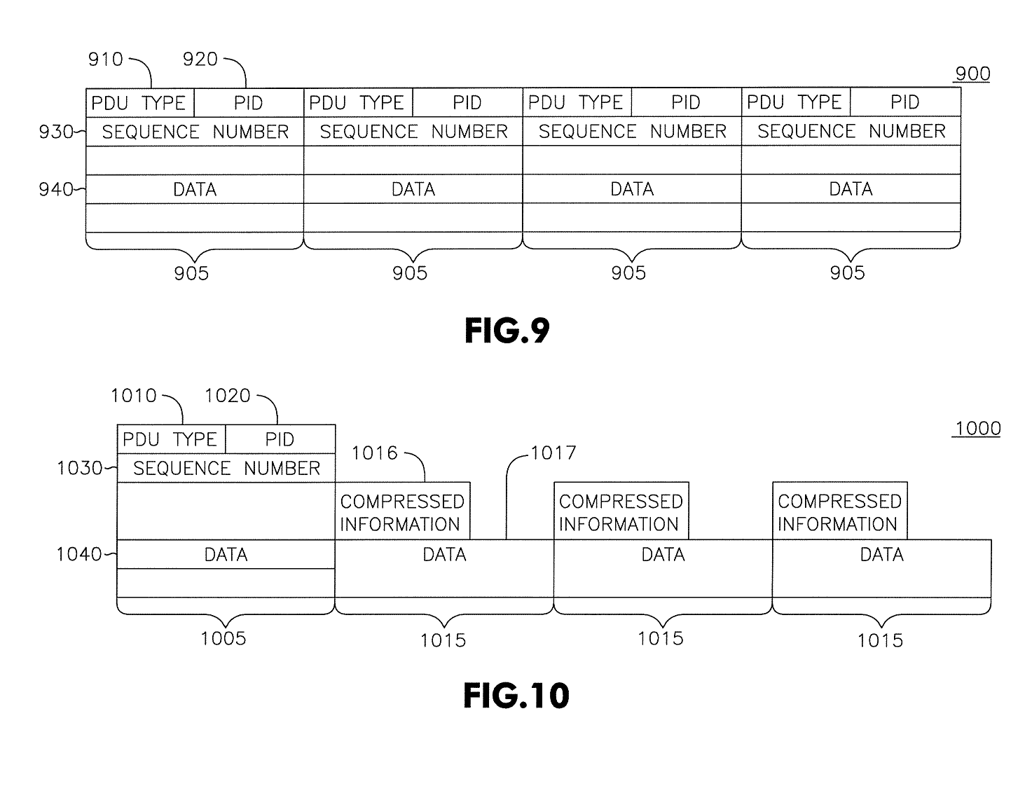

FIG. 9 provides an example of overhead optimization when multiple PDCP PDUs are to be concatenated. The illustration shows the same PDCP PDU format as that of UTRAN systems, however in LTE the format may be different and may include similar or different fields. More particularly, FIG. 9 shows a series 900 of concatenated PDCP PDUs 905 without header compression. Each PDCP PDU 905 may include any of a PDU type field 910, a packet identifier (PID) field 920, an SN 930 and a data field 940. As shown in FIG. 9, each PDCP PDU 905 includes all the header information, which may be made up of any of the PDU type field 910, the PID field 920, and the SN 930.

FIG. 10 shows a series 1000 of concatenated PDCP PDUs with header compression. In FIG. 10, the PDCP PDU 1005 includes a PDU type field 1010, a PID field 1020, an SN 1030 and a data field 1040. However, in PDCP PDUs 1015, the header information is compressed into compressed information 1016.

If the concatenated PDCP PDUs 905/1005/1015 have consecutive sequence numbers and similar PDU type and PID, the compressed info may actually be nil (or very little, e.g. 1 bit as an extra confirmation of such scenario, if desired), since all information can be derived using the information contained in the first PDCP PDU header.

In another variant, the RLC header and/or upper-layer, (e.g., PDCP) header may contain one or more of the following information fields and the fields may be present anywhere in the concatenated packet (i.e. the position may have different possibilities), and several information fields may be combined/optimized into one field.

For each concatenated upper layer PDU, (e.g., PDCP PDU), a field may be used to provide information on whether the upper layer header is present or fully removed. If there is no upper layer header, then the receiving node can regenerate the upper-layer header by assuming that all upper layer header fields are the same as those in the first uncompressed header, except for the sequence number field which should be incremented by one for each concatenated packet. Packet concatenation should be done in an ordered fashion. For example, the sequence number of a subsequent packet should be higher than a packet preceding it.

For each concatenated upper layer PDU, a field may be used to provide information on whether compressed information of the upper layer header is present or not. For example, if the PDU type or PID field is different than that of the first packet, then the compressed information provides such information. If there is a gap, such as a missing upper layer SN, between the concatenated packets, that may be communicated via the compressed information field 1016.

Although there are several variants in which the header fields and compressed information fields 1016 can be designed, most imply a known reference information for decompression, such as the header of the first packet in the concatenation. Additionally, the compressed information fields 1016 define things relative to the decompression reference and communicate the gaps or changes explicitly when necessary.

In one example, the transmitter may set a bit, or a field, in the RLC header or in the upper layer (PDCP) header to indicate whether a compressed or uncompressed header is present. The receiver by default knows how to extract the header from the packet. Basically, either the standard defines the relationship between the compressed and uncompressed header by pre-defining two formats, or prior negotiation, configuration, or setup messages, such as RRC or any control signals, are exchanged to establish the various formats of the headers that can be exchanged. Accordingly, the transmitter may use such bit, or field, to switch between two or more header formats dynamically at any time.

Compression may be used by default (i.e. as the only method) when concatenating multiple other layer PDUs, and in such case there is no need for a bit to explicitly indicate whether compressed or uncompressed headers are present.

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. In a wireless communication system including a wireless transmit/receive unit (WTRU) and an evolved Node B (eNB), capable of transmitting and receiving wireless data, a method for reducing transmission overhead, the method comprising:
receiving an upper layer sequence number (SN);
converting the upper layer SN into a radio link control (RLC) service data unit (SDU) SN (SSN);
generating an RLC protocol data unit (PDU) for transmission including an RLC SSN; and
optimizing an incurred transmission overhead.

2. The method of claim 1 wherein converting the upper layer SN in the RLC SSN includes mapping the upper layer SN into the RLC SSN.

3. The method of claim 2 wherein mapping includes reusing the upper layer SN.

4. The method of claim 3 wherein the upper layer SN is identical to the RLC SSN.

5. The method of claim 2 wherein mapping includes truncating the upper layer SN.

6. The method of claim 2 wherein the RLC SSN is equal to the sum of the upper layer SN and an integer value.

7. The method of claim 6 wherein the integer value is equivalent to an offset.

8. The method of claim 7 wherein the offset is determined from the most significant bits (MSBs) of the upper layer SN.

9. The method of claim 1 wherein optimizing the incurred overhead includes reducing the upper layer SN overhead.

10. The method of claim 9 wherein the upper layer SN is not included in the upper layer header.

11. The method of claim 9, further comprising removing the upper layer SN from the upper layer header prior to transmission.

12. The method of claim 11, further comprising adding a bit to the upper layer header to indicate the presence or absence of the upper layer SN.

13. The method of claim 11, further comprising adding a bit to the RLC header to indicate the presence or absence of the upper layer SN.

14. The method of claim 11 wherein the presence or absence of the upper layer SN is implicitly known to a receiving device.

15. The method of claim 11, further comprising regenerating the upper layer SN at a receiving device.

16. The method of claim 15 wherein the upper layer SN is regenerated from the RLC SSN based on a knowledge of the relationship between them.

17. The method of claim 11, further comprising notifying a receiving node of a relationship between the upper layer SN and the RLC SSN.

18. The method of claim 17 wherein the notification is via in-band signaling.

19. The method of claim 17 wherein the notification is via radio resource control (RRC) signaling.

20. The method of claim 17, further comprising maintaining the relationship between the upper layer SN and the RLC SSN.

21. The method of claim 20 wherein the relationship between the upper layer SN and the RLC SSN is tracked and updated.

22. The method of claim 17 wherein the notification occurs during an initialization or setup phase.

23. The method of claim 17 wherein the notification occurs during any one of the following: RLC initialization, resetting, re-initialization, and handover.

24. The method of claim 1, further comprising compressing the upper layer SN prior to transmission.

25. The method of claim 24, further comprising decompressing the upper layer SN at a receiving device.

26. The method of claim 1 wherein optimizing the incurred overhead includes reducing the upper layer header overhead.

27. The method of claim 26, further comprising removing the upper layer header prior to transmission.

28. The method of claim 27, further comprising concatenating an upper layer PDU.

29. The method of claim 28 wherein the concatenated upper layer PDU includes a field indicating the presence or absence of the upper layer header.

30. The method of claim 27, further comprising regenerating the upper layer header at a receiving device.

31. The method of claim 26, further comprising compressing the upper layer header prior to transmission.

32. The method of claim 31, further comprising concatenating an upper layer PDU.

33. The method of claim 32 wherein the concatenated upper layer PDU includes a field indicating the presence or absence of the compressed upper layer header.

34. The method of claim 31, further comprising decompressing the upper layer header at a receiving device.

35. The method of claim 1 wherein the generated RLC PDU contains any one of a segment of an upper layer packet or multiple upper layer packets.

36. In a wireless communication system, a method for reducing transmission overhead, the method comprising:
concatenating PDCP PDUs which have consecutive SNs;
including in the concatenated packet the header information of the first PCDP PDU; and
regenerating the headers for each PDCP PDU based on the information of the first PDCP PDU, whereby the PDCP SN is incremented by 1 for each subsequent PDCP PDU.

37. In a wireless communication system including a wireless transmit/receive unit (WTRU) and an evolved Node B (eNB) capable of transmitting and receiving wireless data, a method for reducing transmission overhead, the method comprising:
receiving a radio link control (RLC) service data unit (SDU) SN (SSN); and
converting the RLC SSN into an upper layer sequence number (SN);

38. A wireless transmit/receive unit (WTRU), comprising:
a receiver for wirelessly receiving data;
a transmitter for wirelessly transmitting data; and
a translation compression optimization (TCOP) functional block, the TCOP functional block configured to receive an upper layer sequence number (SN), convert the upper layer SN into a radio link control (RLC) service data unit (SDU) SN (SSN), generate an RLC protocol data unit (PDU) for transmission including an RLC SSN, and optimize an incurred transmission overhead.

39. An evolved Node B (eNB), comprising:
a receiver for wirelessly receiving data;
a transmitter for wirelessly transmitting data; and
a translation compression optimization TCOP) functional block, the TCOP functional block configured to receive an upper layer sequence number (SN), convert the upper layer SN into a radio link control (RLC) service data unit (SDU) SN (SSN), generate an RLC protocol data unit (PDU) for transmission including an RLC SSN, and optimize an incurred transmission overhead.
